(19) United States
(12) Patent Application Publication
(10) Pub. No.: US 2007/0243723 A1
(43) Pub. Date: Oct. 18, 2007

(54) Dual interface wireless transmitter structure

(75) Inventor: Chia-Nan Liao, Taipei (TW)

Correspondence Address: HDSL, 4331 STEVENS BATTLE LANE, FAIRFAX, VA, 22033, US

(73) Assignee: BeCell Innovations Corp.

(21) Appl. No.: 11/399,326

(22) Filed: Apr. 7, 2006

(51) Int. Cl. H01R 39/00

(52) U.S. Cl. 439/1

(57) ABSTRACT

A dual interface wireless transmitter structure having two different transmission interfaces includes a rectangular base and a first transmission interface disposed at an end of the base. Another end of the base is in a curved shape, and the curved surface includes a second transmission interface and the curved surface a knob therein. Such that the second transmission interface has a turning effect, and an edge of the knob includes a fixing key for fixing the turning position of the knob. The middle of a lateral side of the base includes a switch key for switching the two transmission interface control modes and a panel of the base includes a search key for transmitting a signal for searching and connecting a receiver within a receiving range.

### BACKGROUND OF THE INVENTION

1. Field of the Invention

The present invention relates to a transmitter structure, and more particularly to a wireless transmitter structure capable of transmitting data or sound source.

2. Description of Prior Art

The development of wireless transmission technology, such as Bluetooth brings another revolution to the new-generation wireless application transmission technology, not only opening a new era for the personal transmission technology, but also provides various different applications to satisfy different requirements including small devices such as notebook computers and mobile phones or large devices such as automobiles. The wireless transmission technology plays an important role indispensable to our life and get rids of the hassle of the cables to allow us to live in an unrestricted living environment.

Simply speaking, Bluetooth is a low-cost short-distance wireless transmission technology, and its major features reside on its support to the connection to a Bluetooth product within a short distance for the function of transmitting data including images, instructions and sounds. For example, a mobile phone can be connected to an earphone for a wireless telephone call, and a computer can be synchronized with the mobile phone through Bluetooth without being limited by space and location. Compared with the infrared technology, Bluetooth not only transmits data faster, but also allows data to be received at any location or direction within a transmitting range. Thus, Bluetooth wireless technology has replaced cables and connectors specially used for various electronic devices in offices, homes, or outdoor.

In the present Bluetooth wireless technology, the operation of sounds includes a wireless transmitter and a receiving earphone, wherein the wireless transmitter connected to various different devices such as mobile phones or walkmans capable of outputting a sound source becomes a usable mobile multimedia tool, and most interfaces of the present wireless transmitters and audio output devices adopt a single USB interface or an audio output terminal electrically coupled to each other, so that the audio output device allows users to synchronously receive a sound transmission through the wireless connection of the wireless transmitter and the receiving earphone.

Most devices having the audio output function adopt a universal serial bus (USB) interface and a connecting interface for output terminals, but traditional plug-and-play wireless transmitters adopt a single connecting interface which brings another kind of inconvenience to users. If a user uses the same set of wireless transmitter and receiving earphone for a different device, the user can only use such set for the device with the same connecting interface of the wireless transmitter. In other words, users have to prepare a wireless transmitter with a different interface if the users want to use the same wireless transmission device for a peripheral output device. Such requirement cannot achieve the integrating effect, but it creates a problem of requiring users to switch the earphone to receive sound sources from different devices, and thus the design requires further improvements.

### SUMMARY OF THE INVENTION

In view of the foregoing shortcomings of the prior art, the inventor of the present invention based on years of experience in the related industry to conduct experiments and modifications, and finally designed a dual interface wireless transmitter structure in accordance with the present invention to overcome the shortcomings of the prior art.

Therefore, the present invention is to overcome the shortcomings of the prior art by providing a dual interface wireless transmitter structure having two different connecting interfaces. The wireless transmitter integrates two different connecting interfaces into the same transmitter and thus users no longer need to integrate additional wireless transmission devices into the same transmitter for the peripherals of an electronic product with an audio output function.

The present invention provides a dual interface wireless transmitter structure that includes a rectangular base, a first transmission interface disposed on a surface of the base, and another end of the base is in a curved shape, and the curved surface includes a second transmission interface, and the curved surface includes a turning layer therein, such that the second transmission interface has a turning effect, and an edge of the turning layer includes a fixing key for fixing the turning position of a knob, and the middle of a lateral side of the base includes a switch key for switching two transmission interface control modes.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of the present invention;

FIG. 2 is a schematic view of a rotary layer of the present invention;

FIG. 3 is a schematic view of an operation of the present invention;

FIG. 4 is another schematic view of an operation of the present invention;

FIG. 5 is a schematic view of another operation of the present invention;

FIG. 6 is another schematic view of another operation of the present invention; and

FIG. 7 is a schematic view of an operation of another structure of the present invention.

### DETAILED DESCRIPTION OF THE INVENTION

The technical characteristics, features and advantages of the present invention will become apparent in the following detailed description of the preferred embodiments with reference to the accompanying drawings.

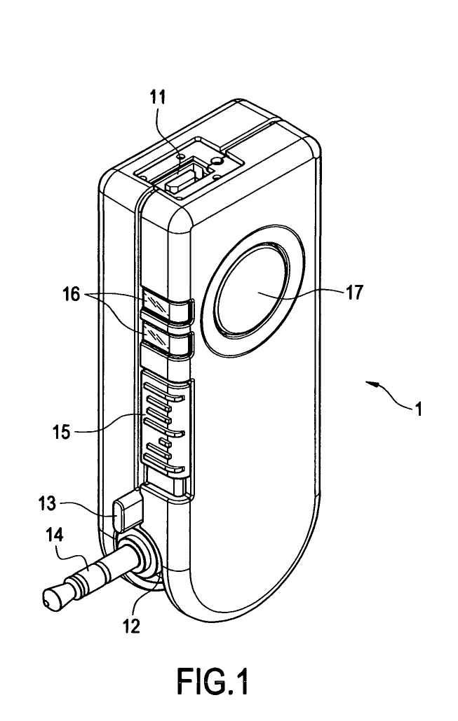

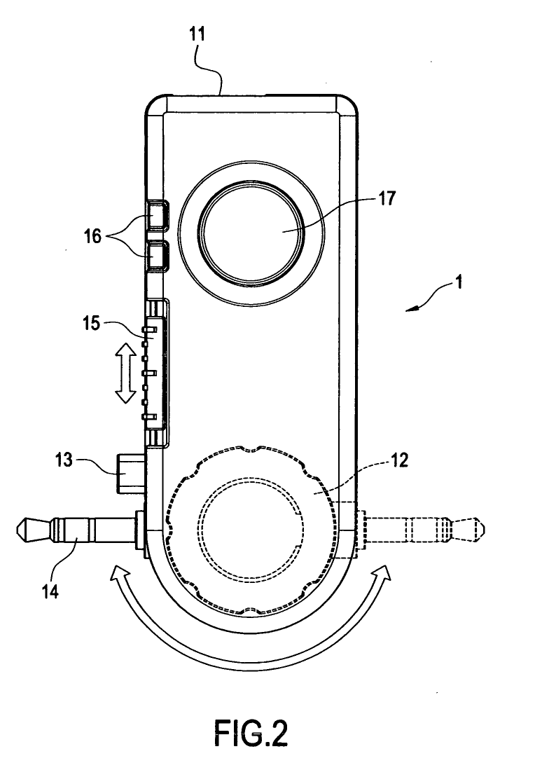

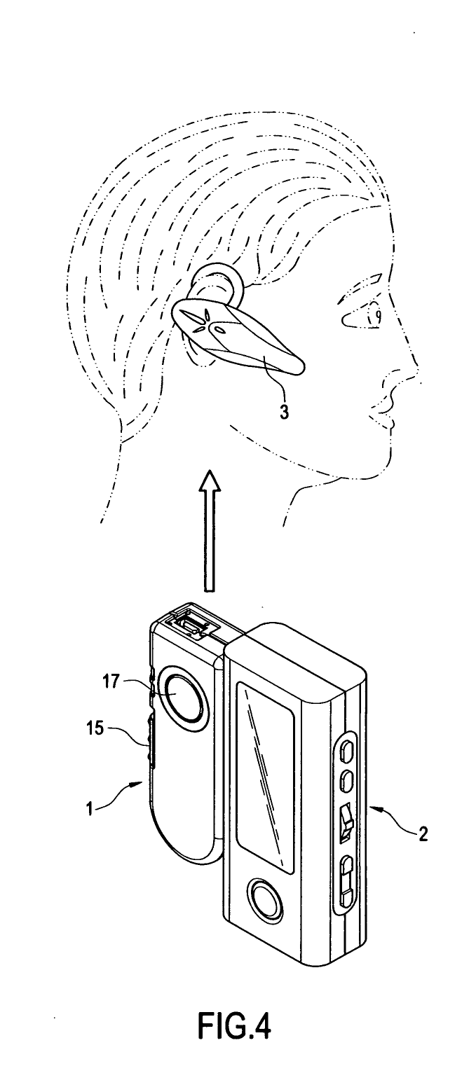

Referring to FIG. 1 for the perspective view of a structure of the present invention, a wireless transmitter base 1 of the base 1 is in the form of a cuboid and an end of the base 1 includes a first transmission interface 11 which is a universal serial bus (USB) interface in this embodiment, and the interface 11 is a female-end interface, and another end of the base 1 includes a knob 12 therein as shown in FIG. 2, and an edge of the knob 12 includes a fixing key 13 for fixing the turning position of the knob 12. In the meantime, the knob 12 includes a second transmission interface 14 which is an audio input terminal in this embodiment, and the second transmission interface 14 can be turned to a 180-degree position by the turning effect of the knob 12. The base 1 at the lateral side of its middle includes a switch key 15 for switching the two transmission interface control modes and the lateral side of the switch key 15 includes two status indicating lamps 16 for indicating the using mode of the wireless transmitter, and the panel of the base 1 includes a search key 17 electrically coupled to an internal control unit for sending out a signal to search a receiver 3 within a receiving range as shown in FIG. 4.

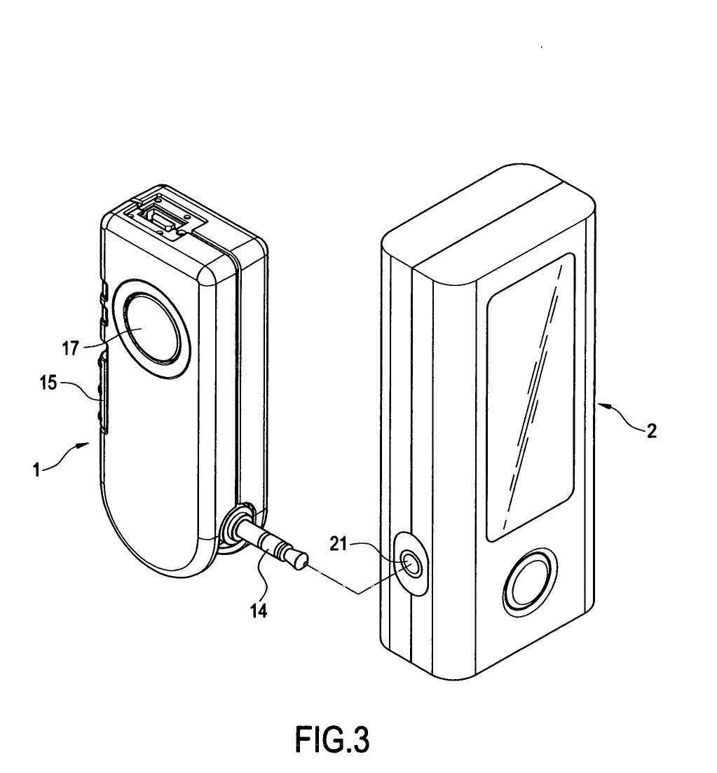

Referring to FIG. 3 for the schematic view of the operation of the present invention, a user can connect the second transmission interface 14 of the wireless transmitter 1 to an audio output hole 21 of a walkman 2 for listening to the walkman 2 by a wireless transmission technology. Referring to FIG. 4, a switch key 15 of the wireless transmitter 1 can be used to switch the using mode to the second transmitter interface 14 after the wireless transmitter 1 and the walkman 2 are connected, and the search key 17 can be used to search and transmit signals to a user's receiver 3, so that the user can listen to the output sound source from the walkman 2.

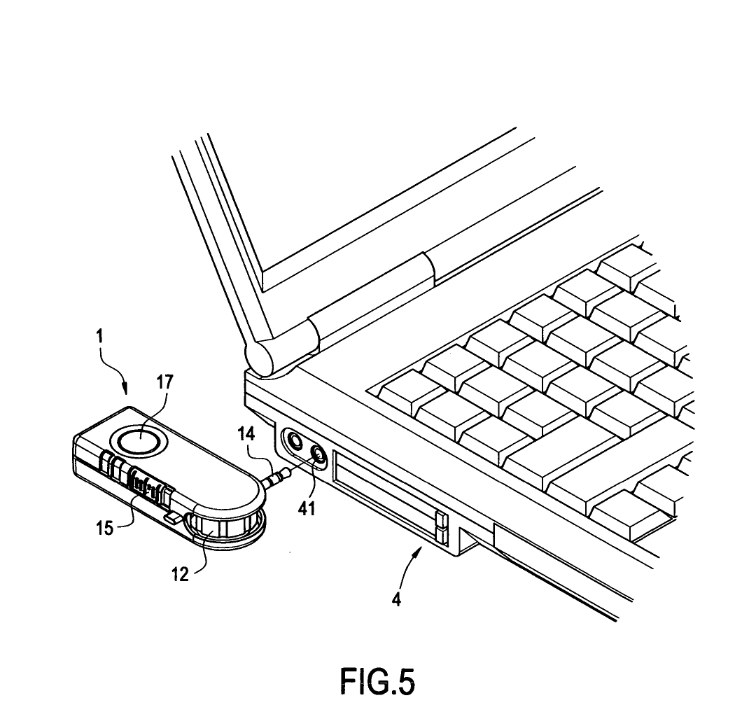

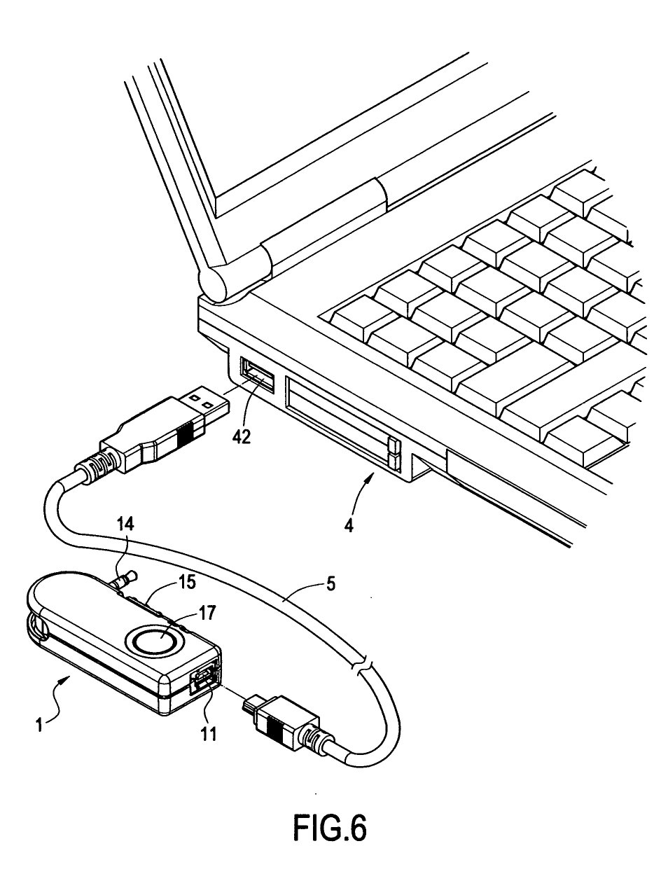

Referring to FIG. 5 for the schematic view of the operation of another preferred embodiment of the present invention, a user can connect the wireless transmitter 1 to a computer 4 and electrically connect wireless transmitter 1 to an audio output end 41 of the computer 4 through the second transmission interface 14, such that the sound source outputted by the computer 4 can be connected to the wireless transmitter 1 and the receiver 3 in a wireless manner to facilitate users to listen to the outputted sound source without being restricted by cables. In FIG. 6, the computer 4 also can be connected by using the first transmission interface 11 to connect the USB transmission interface 42 of the wireless transmitter 1 and the computer 4 through a transmission cable 5, and the switch key 15 of the wireless transmitter 1 can switch the control mode to the interface 15, so that users also can receive the inputted sound source of the computer 4.

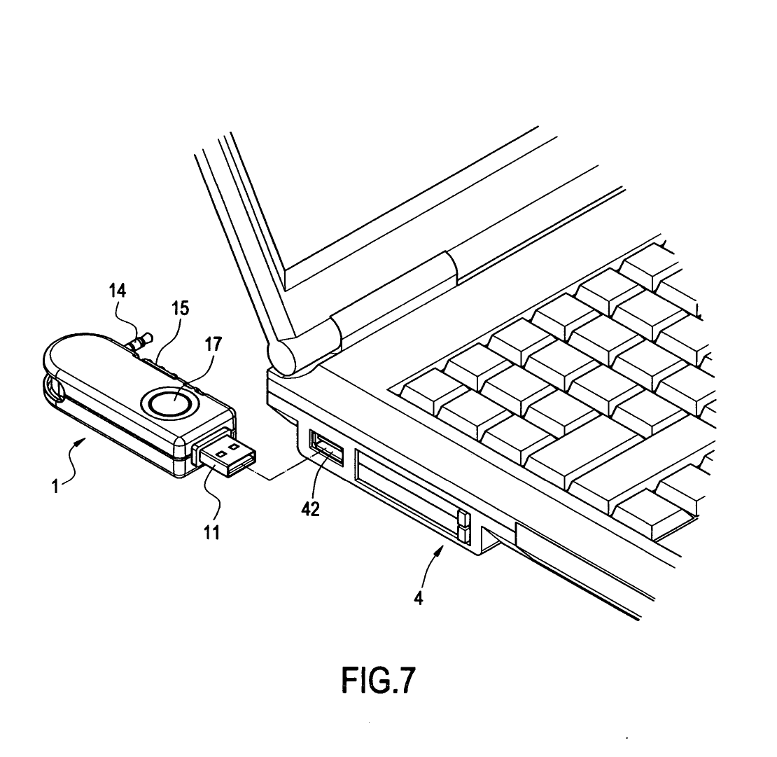

Referring to FIG. 7 for the schematic view of the operation according to another structure of the present invention, the first transmission interface 11 installed on the wireless transmitter base 1 has a male-end interface of the universal serial bus (USB) interface, so that the wireless transmitter 1 can be connected to the audio output device directly by the first transmission interface 11 and connected directly to a female-end USB interface 42 of the computer 4 as shown in the figure to facilitate users to receive the sound source from the computer through the wireless transmitter 1.

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A dual interface wireless transmitter structure, which is applied to an electronic device capable of outputting a sound source, comprising:
a wireless transmitter base;
a first transmission interface, disposed at an end of the wireless transmitter base for receiving a digital signal; and
a second transmission interface, disposed at another end of the wireless transmitter base for receiving an analog signal.

2. The dual interface wireless transmitter structure of claim 1, wherein the wireless transmitter base includes a knob disposed inside an end of the base.

3. The dual interface wireless transmitter structure of claim 2, wherein the knob includes a fixing key disposed at an edge of the knob.

4. The dual interface wireless transmitter structure of claim 1, wherein the wireless transmitter base includes a switch key.

5. The dual interface wireless transmitter structure of claim 1, wherein the first transmission interface is a universal serial bus interface.

6. The dual interface wireless transmitter structure of claim 1, wherein the second transmission interface is an audio source terminal.

7. The dual interface wireless transmitter structure of claim 1, wherein the first transmission interface is a universal serial bus interface and the second transmission interface is an audio terminal.
